(19) United States
(12) Patent Application Publication
(10) Pub. No.: US 2021/0291917 A1
(43) Pub. Date: Sep. 23, 2021

(54) Tracked Drag Force Generating Device

(71) Applicant: Brian Eckberg, Pulaski, WI (US)

(72) Inventor: Brian Eckberg, Pulaski, WI (US)

(21) Appl. No.: 16/826,817

(22) Filed: Mar. 23, 2020

(51) Int. Cl. B62D 55/12; B62D 55/14

(52) U.S. Cl. CPC B62D 55/12; B62D 55/18; B62D 55/14

(57) ABSTRACT

A device for generating a pulling, or drag, force. The device consists of a single large track, powered by a power source located on a bottom wall above said track; of which the power source is an electric or combustion engine, mechanically connected with a multitude of rollers. The device additionally consists of an elongated handle with a generally t-shaped or generally u-shaped distal end so as to be received and grasped by a human user. Additionally, side walls and an optional front and/or overhead wall may be utilized to protect the power source from the elements.

### FIELD

The present disclosure is directed to the field of powered pulling devices, and more particularly to continuous tracked powered drag force apparatuses that have the capability to pull a weight such as a trailer or a human user across varying terrains.

### BACKGROUND OF THE INVENTION

The Earth is full of rough terrain which is difficult for humans to traverse, particularly with respect to ability of speed. For many years humans have tried various methods to travel these difficult areas. The earliest method was by merely walking. Later, humans were able to domesticate animals such as horses so as to utilize their superior strength and endurance to travel longer distances.

Animals work well for travel in many circumstances but as is well-known they still require maintenance, such as food and water. Additionally, horses can struggle in difficult terrain such as snow and ice which may lead to the horse breaking its ankle, thus rendering the animal disabled and unable to continue. Most recently in human history humans have developed self-propelled vehicles to accomplish these draining tasks.

The wheel has been utilized in many advancements such as the automobile. While they work well in and on many surfaces, wheels have a generally small surface area and can get easily stuck in terrain such as snow and mud. Additionally, rocky terrain allows for the wheel to get jammed in a crevice and incapacitate the vehicle.

To prevent some of the above-mentioned issues on motorized vehicles, the advancement of a continuous track system was developed. The continuous track provides a large surface area and greatly reduces incapacitations due to rugged terrain. Vehicles employing a continuous track can safely negotiate difficult landscapes that are inaccessible to wheeled vehicles.

One of the present-day problems with continuous track vehicles, also known as tracked vehicles, is that these types of vehicles generally have less speed and maneuverability comparatively. This requires more power to be dispersed and thus increases the cost-per-mile when calculated vs. a wheeled vehicle. Additionally, a tracked vehicle most likely will require more maintenance over a period of years than would a wheeled vehicle.

Despite these issues, many people today enjoy utilizing the benefits of a continuous track system to traverse otherwise unattainable destinations, either for commercial use, agricultural use, or even for recreational use. Indeed, most snowmobiles today have skis on the front end of the vehicle with a track or tracks on the rear end. In most units, power is provided to the rear tracks which propels the snowmobile forward and with the skis. Snowmobiles provide the excitement of a recreational vehicle such as a motorcycle while on the difficult terrain of snow or ice.

However, people today may desire a different method of transportation, one where they are not required to sit on top of a vehicle. They may also desire to utilize their method of transportation in a different terrain that is generally not accessible to most snowmobiles, such as a rocky or a muddy terrain.

What is needed, therefore, is a device which can pull a weight such as a trailer or a person to a known location, while being capable of crossing through multiple difficult terrains.

### BRIEF SUMMARY

The present disclosure is directed to a tracked drag force generating device for the purpose of traversing a wide variety of different terrains. The device of the present disclosure further has the capability of pulling a human user who is on runners, known herein as devices such as skis, skates, roller-skates, rollerblades, a sled, or a snowboard, to name a few.

The device of the present disclosure generally has a frame and a single continuous track in a centrally located position relative to the device frame. According to some embodiments of the present disclosure, the track may be constructed out of a variety of materials, provided the track is capable of withstanding repetitive ground-contact force. Some examples of possible material used is a metal track, a rubber track, a composite track, or any other durable material.

According to some embodiments, within the track will be sprocket rollers that contact within the internal bearings of the track. The sprocket is positioned where the track is disposed around it and the sprockets thus are positioned in at least a front and a rear position. In such a fashion the track flows from a position behind the rear sprocket towards a position known as beyond the front sprocket, creating a consistent loop. It is presently thought that two sprockets are used, however an additional middle sprocket, as determined based upon linear position as to the front sprocket and rear sprocket, may be utilized to provide additional support. Additional middle sprockets may be added and are also disclosed and supported within this specification. To encourage stability, general rollers may also be provided in place of middle sprockets. One embodiment of the said rollers are wire-cage rollers, which are a generally welded heavy duty wire roller which allows for some debris to enter without clogging the roller or rollers.

Some embodiments of the track may be a generally smooth track which may be advantageous for certain landscapes. However, other embodiments of the track contain a plurality of treads, which allow for greater grip and contact with the ground surface. Both embodiments are thought to be covered by this disclosure, as the track itself may be customizable depending on the terrain of the intended use. In most circumstances the track may best be served by containing a variety of threads at various heights, so as to allow for greater grip on the ground, but for ice surfaces and the like a smoother surface may be desired.

Within the track may be positioned what is known herein as a skid plate. The skid plate is a generally curved piece of durable material such as aluminum, steel, hard plastic or the like, upon which debris is pushed outside the interior of the track, and may also be used to push, or plow, snow out of the rear of the continuous track.

The sprockets generally may have additional sprocket teeth which engage with the continuous track and allow for the proper positioning thereof. At least one of the sprockets in some embodiments has an axle disposed within and extending beyond the sides of said sprocket, creating a generally central shaft, and thus the terms axle and axle shaft are used synonymously herein. The axle has a support arm which contacts with the frame, and positions said frame above the continuous track without making contact therewith. Thus, the main purpose of said support arm or support arms should two, or more as the case may be, sprockets have axles is to position said frame.

The frame may be generally thought of as having rigidity but also creates the support for a cab to be positioned thereon. The cab, as is used herein, is thought to be a series of structural support walls that create a general volume therebetween. The support walls are thought to be opposing faced side walls, and a front shield wall to prevent snow, water, or debris from entering the volume of the cab.

The cab or frame upon which the cab sits, has an elongated handle positioned thereon. The elongated handle is presently thought to be pivotably connected such that its vertical position is adjustably positioned relative to the device. A further tilt mechanism may also be used to allow for customization of general positioning of the handle. The elongated handle may have further components thereon which allow for better ergonomic grip of the handle, and thus enables a human user to sustain a grip on the handle for a longer period of time.

Within the volume of the cab at an exact position therein as determined dependent upon intended use, is a power source. The power source is presently thought to be an internal combustion engine which may additionally contain a centrifugal clutch or a mechanical clutch, or the power source may be an electric motor, though any source of providing power may be used without departing from the spirit of the disclosure. Should the power source require it, a fuel reserve may also be located within the cab, such as a fuel tank, or a place for a battery, fuel cell, or the like.

The power source is generally mechanically connected to one of the sprockets and provides the power to said sprocket. Upon receiving the power, the sprocket is caused to rotate, and thus engage with the continuous track. This movement causes the track itself to move from its position around the above-mentioned created continuous loop.

On the exterior portion of the cab sidewalls or front shield wall or upon the exterior of the handle may additionally be a headlight. The headlight allows for illumination of the area surrounding the device in times of low-light visibility. Said headlight may contain an external power source such as batteries or may alternatively be connected to the power source. It is also presently contemplated that a horn is provided to the exterior of the cab sidewalls or the exterior of the handle. The horn has a user activated device such as a push button so the user may provide noise-notification to the surrounding area.

On the exterior portion of the device may additionally be a trailer hitch, which allows for connectability to a small trailer or the option to pull external devices, such as sleds, vehicles, or the like. This particular optional component may be best used when the device is hauling material to hard-to-reach locations, or perhaps on a search and rescue mission. In much the same sense, additional baskets, carriers, totes, or boxes may be positioned within or near the cab for transportation of goods or supplies. It is also contemplated a cup holder could be present within the cab as well.

The handle in some embodiments additionally contains a throttle control apparatus, such as a twist grip throttle, a push-button throttle, or a thumb throttle to name a few options. The type of throttle used may vary, but the throttle is known herein as the mechanism by which the human user is able to regulate the power source. In such a fashion, the human user may cause the increase in power and thus rotational speed of the continuous track. In some embodiments, the handle is shaped like a T″, similar to that of a floor buffer, or a “U” shape similar to that of some lawnmowers, or any handlebar which may be readily used by humans, such as any of the numerous available bicycle handle variations without departing from the spirit of the disclosure. In one embodiment, the ends of the handle have ergonomic grips containing a twist throttle, similar to that of common motorcycles. The tracked drag force generating device when the throttle is engaged thus moves forward, in a linear direction relative to the rear sprocket beyond that of the front sprocket.

Should a user desire to move the device in a direction other than that of the linear path currently traveling, the user applies force on the handle in such a fashion that the continuous track is released from flat contact with the ground and is at a diagonal position where only a side of the continuous track contacts with the ground, in a fashion similar to that of turning on a snowboard or a skateboard. In such a fashion, the continuous track is only partially contacting the ground at a position on the track where the user desires the track to move.

These and various other features, advantages, modes, and objects of the present disclosure will be made apparent from the following detailed description and any appended drawings.

### DESCRIPTION OF THE DRAWINGS

One or more preferred exemplary embodiments of the present disclosure are illustrated in the accompanying drawings in which like reference numerals represent like parts throughout and in which:

FIG. 1 is a perspective view of a preferred embodiment of the tracked drag force generating device while said device is pulling a human user who is wearing skis;

FIG. 2 is a perspective view of one embodiment of the elongated handle of the tracked drag force generating device containing a thumb throttle and having tilt capabilities;

FIG. 3 is a perspective rear view of a preferred embodiment of the tracked drag force generating device containing a power source located within the cab;

FIG. 4 is a sectional view of a preferred embodiment of the tracked drag force generating device wherein the tracked drag force generating device contains multiple sprockets, and features a skid plate; and

FIG. 5 is a side perspective view of a preferred embodiment of the tracked drag force generating device wherein a headlight is shown with the power source contained therein, and additionally comprising a skid plate within the surface of the continuous track.

Before explaining one or more embodiments of the disclosed disclosure in detail, it is to be understood that this disclosure is not limited in its application to the details or modes of construction and the arrangement of the components set forth in the following description or previously disclosed illustrations. This disclosure is capable of multiple embodiments and modes, which can be practiced or carried out in many various ways. Also, it is to be understood that the phraseology and terminology employed herein is for the purpose of description, and should not be regarded as limiting, or used as an absolute.

### DETAILED DESCRIPTION OF INVENTION

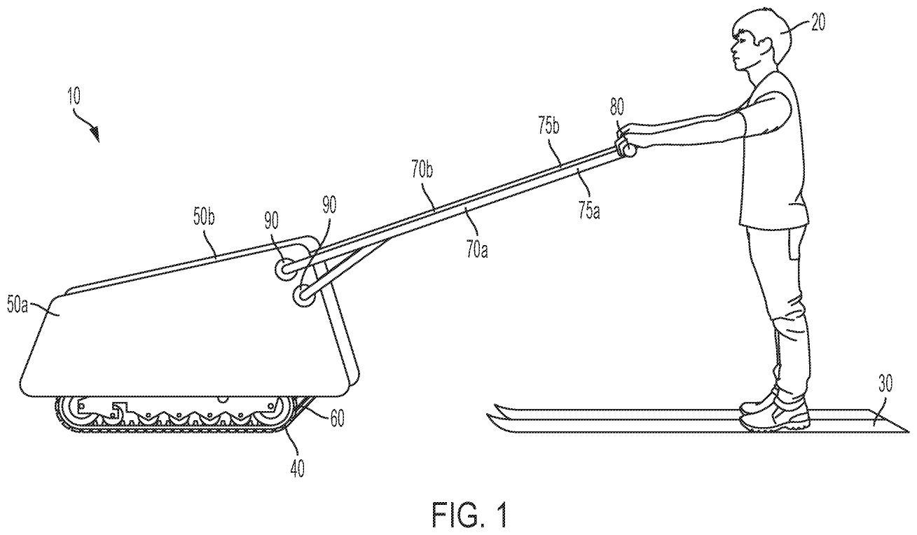

Referring now to the drawings in detail, FIG. 1 illustrates a preferred embodiment of a tracked drag force generating device 10 constructed in accordance with the present disclosure. The tracked drag force generating device 10 is shown here emitting a drag force and pulling a human user 20, of whom is presently on runners 30. As described above, the runners 30 may be in the form of skis, a snowboard, skids, roller skates, ice skates, a sled, or the like. The tracked drag force generating device 10 has a continuous track 40, of which in this illustration also contains treads 60, which provide additional grip on the contact surface of the ground. The track 40 is contained within a frame that has side walls 50a, 50b. Attached to or near the side walls 50a, 50b at a connection point 90 are handle lower legs 70a, 70b. These handle lower legs are connected with handle upper legs 75a, 75b. At a distal end on the handle upper legs 75a, 75b away from the tracked drag force generating device 10 is a handle push bar 80, which is known herein as the part of the overall handle in which a human user 20 grasps, or connects an alternate device such as a rope, chain, clamp or the like thereto.

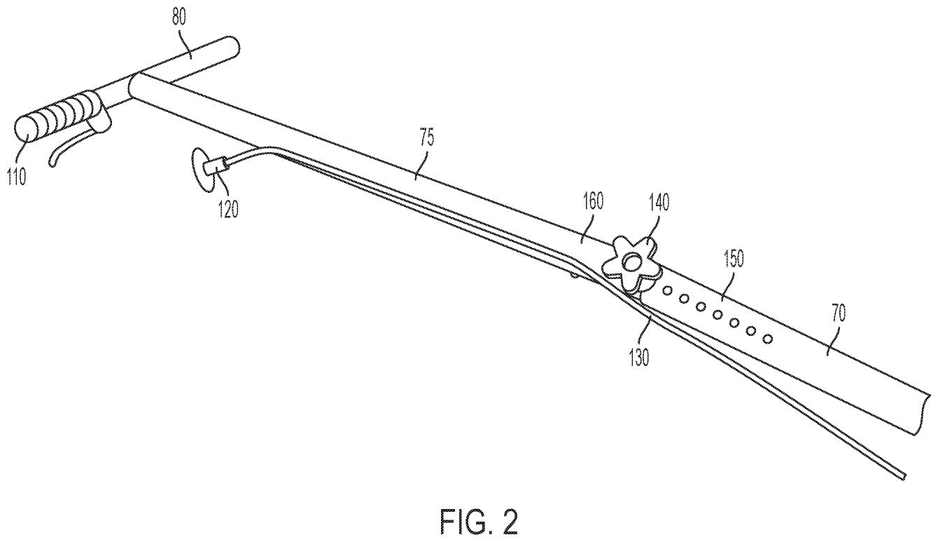

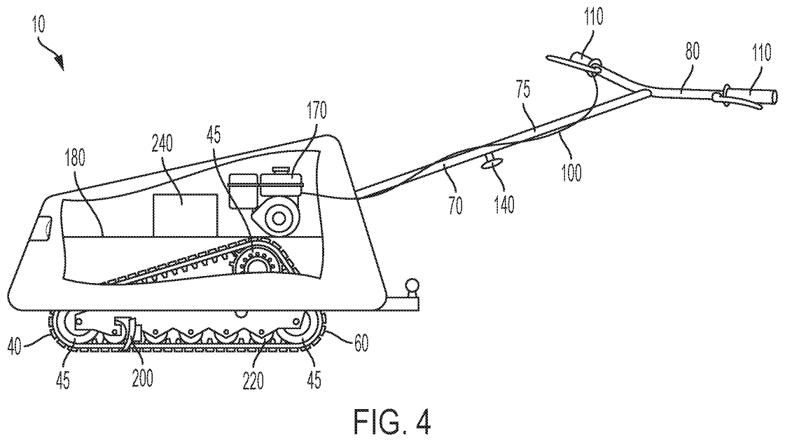

Looking at FIG. 2 is one embodiment of a handle device of the tracked drag force generating device 10 in which the handle is shaped as a “T.” This version has a handle lower leg 70 which additionally comprises a handle extension 150 device. This handle extension device gives the capability of extending the length of the handle lower leg 70 so as to extend the distance of the handle push bar 80 from the tracked drag force generating device 10 itself. Also illustrated here is a handle tilt knob 140, which allows for the adjustability of the handle upper leg 75 angle from the handle tilt knob 140 which is used as the vertex for adjustability purposes. Another feature in this embodiment is a handle extension 160 for the handle upper leg 75, and further allows for increasing or decreasing the distance of the handle push bar 80 from the tracked drag force generating device 10 itself. On the distal end of the handle upper leg 75 is the handle push bar 80, which contains a user-actuated throttle 110. The throttle 110 of the device may be in any shape or method as convenient under the circumstances but it is thought presently that it be best deployed on the handle push bar 80 itself. This embodiment also shows the presence of a starter handle 120 and starter cable 130, which allows for the activation of a power source 170, as shown in detail in FIG. 4.

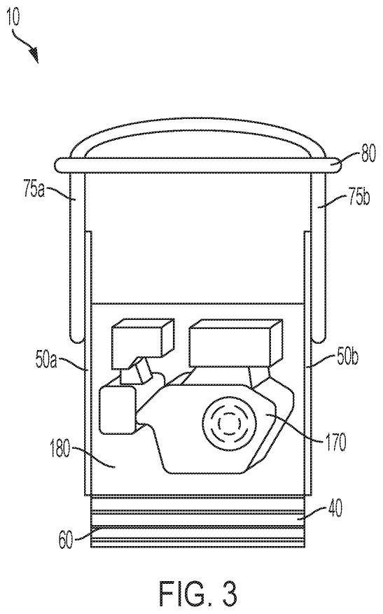

Turning now to FIG. 3, a user perspective view from the back of the tracked drag force generating device 10 is illustrated. This particular view is that which a human user 20 would see while operating this embodiment. As shown, a power source 170 is depicted within the side walls 50a, 50b of the tracked drag force generating device 10. Connected to said side walls 50a,50b creating a device frame and located above the track 40 is a lower frame wall 180. This lower frame wall 180 is the base upon which said power source 170 is generally seated.

FIG. 4 illustrates a sectional view of an embodiment of the tracked drag force generating device 10. The track 40 is shown in detail here, complete with multiple sprocket rollers 45, which are mechanically connected in a way with the power source 170, and the power source engages at least one sprocket roller 45, of which sprocket rollers 45 are in contact with the track 40 itself by way of the sprocket teeth. By inducing the sprocket roller 45 to move, the track 40 itself is mechanically induced to move, which provides the mobility. The track 40 additionally contains treads 60, and has a series of rollers 220, to provide extra stability to the track 40. Shown in this embodiment additionally is a skid plate 200, which allows for the dispersion of material such as snow, to be distributed in a location outside that of the track 40. In so doing, the track 40 is protected from buildup from outside materials. Also connected to a sprocket roller 45 are connection points which allow the frame to sit. The lower part of the frame, as previously described, is the lower frame wall 180, and as shown here the power source 170 sits thereon. Also located on the lower frame wall 180 in this embodiment is a tote 240, which is a basket or carrying device such that a human user 20 is able to bring additional items. The size and shape of the tote 240 can be adjustable based on the particular needs of the human user 20 themselves. The handle lower leg 70 is connected to the tracked drag force generating device 10 and is shown here with a handle tilt knob 140 connected to the handle upper leg 75. In this particular embodiment, the starter handle 120 is not shown as it is located on the power source 170 and therefore is not on the handle itself. On the handle push bar are two user-actuated throttles 110, for the human user 20 to utilize. A throttle cable 100 is shown, connected on one end to the power source 170 and on the other end of the cable to the throttle 110.

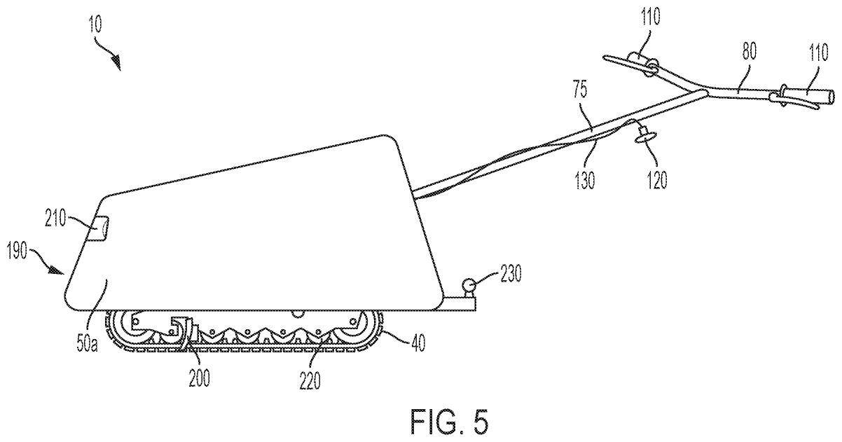

Lastly, we look at FIG. 5. In this illustration, a version of the tracked drag force generating device 10 is shown wherein the track 40 contains a skid plate 200. Most of the track 40 is covered by the side wall 50a, but enough is shown to highlight the present of rollers 220. The frame of the tracked drag force generating device 10 has a front shield wall 190, which is the same as a side wall 50, but located on the front of the tracked drag force generating device 10, a location known as the farthest distance from the handle push bar 80. On said front shield wall 190 is located a headlight 210. The headlight 210 naturally provides illumination in periods of low-light visibility. It is thought that the headlight 210 may be able to receive power from a stator within the power source 170, or from an external power source such as batteries. On the rear location of the tracked drag force generating device 10, closet to the handle push bar 80 is a trailer hitch 230. This allows for a human user 20 to attach a sled, trailer, or other similar device. Depending on the circumstances, in such a way a user may attach said device and sit thereon, while grasping the handle push bar 80 and actuating the throttle 110 to provide transportation of said device by way of the tracked drag force generating device 10.

Understandably, the tracked drag force generating device 10 has been described above in terms of one or more preferred embodiments or models. It is recognized that various alternatives and modifications may be made to these embodiments and methods that are within the scope of the present disclosure. Any and all various alternatives reasonably obvious to a person of skill in the art are contemplated as being within the scope of the present disclosure. It is also to be understood that, although the foregoing description and drawings describe and illustrate in detail one or more preferred embodiments of the tracked drag force generating device 10, to those skilled in the art of which this disclosure relates, namely transportation by way of light vehicle, the present disclosure will suggest many modifications, models, and constructions, as well as widely differing embodiments and applications without thereby departing from the spirit and scope of the disclosure.

What is claimed is:

1. A drag force generating device, comprising:
a front sprocket roller having a first side and a second side;
an axle disposed within the front sprocket roller and extending beyond the first side and the second side of the front sprocket roller;
a rear sprocket roller having a first side and a second side, the rear sprocket roller generally positioned linearly with the front roller along on a longitudinal axis of the device;
an axle disposed within the rear sprocket roller and extending beyond the first side and the second side of the front sprocket roller;
a track disposed around the front sprocket roller and the rear sprocket roller;
a first support arm having a first distal end and a second distal end, said first support arm coupled to the front sprocket roller axle on the first distal end of the first support arm;
a second support arm having a first distal end and a second distal end, said second support arm coupled to the rear sprocket roller axle on the first distal end of the second support arm;
a frame coupled to the second distal end of the first support arm, and wherein said frame is additionally coupled to the second distal end of the second support arm;
a cab mounted on the frame, said cab having a front shield wall and a plurality of opposite side walls;
a power source positioned within the cab, wherein the power source is mechanically connected to one of the front sprocket roller axle and the rear sprocket roller axle;
an elongated handle pivotably connected to the frame;
a throttle cable having a first end and a second end, wherein the throttle cable is mechanically connected to the power source at the first end; and
a throttle control apparatus mechanically connected to the second end of the throttle cable, wherein the throttle control apparatus is mounted on the elongated handle.

2. The drag force generating device of claim 1, and wherein the track further comprises a plurality of treads thereon.

3. The drag force generating device of claim 2, and further comprising a middle sprocket roller having a first side and a second side, the middle sprocket roller generally positioned in between the front sprocket roller and the rear sprocket roller along the longitudinal axis of the device, and wherein the track is disposed additionally around said middle sprocket roller.

4. The drag force generating device of claim 3, wherein an axle is disposed within the middle sprocket roller and extending beyond the first side and the second side of the front sprocket roller.

5. The drag force generating device of claim 4, wherein the power source is an internal combustion engine.

6. The drag force generating device of claim 5, further comprising a headlight mounted on the cab.

7. The drag force generating device of claim 6, wherein the throttle control apparatus is an ergonomic shape.

8. The drag force generating device of claim 7, wherein the internal combustion engine further comprises a centrifugal clutch.

9. The drag force generating device of claim 4, wherein the power source is an electric motor.

10. A tracked powered machine comprising:
a frame;
a cab mounted on the frame, said cab having a plurality of opposing side walls;
a first support arm having a first distal end and a second distal end, said first support arm coupled to the frame at the second distal end of the first support arm;
a second support arm having a first distal end and a second distal end, said second support arm coupled to the frame at the second distal end of the second support arm;
a front sprocket roller having a first side and a second side and additionally including an axle disposed within the front sprocket roller extending beyond the first side and the second side of the front sprocket roller, said axle coupled to the first distal end of the first support arm, wherein the front sprocket roller is disposed at a position below the frame opposite that of the cab;
a rear sprocket roller having a first side and a second side and additionally including an axle disposed within the rear sprocket roller extending beyond the first side and the second side of the rear sprocket roller, said axle coupled to the first distal end of the second support arm, wherein the rear sprocket roller is disposed at a position below the frame opposite that of the cab;
a track disposed around the front sprocket roller and the rear sprocket roller;
a plurality of rollers positioned at a position between the front sprocket roller and the rear sprocket roller, said plurality of rollers disposed within the track;
a power source mounted within the cab, wherein said power source is mechanically connected to the rear sprocket roller axle;
an elongated handle pivotably connected to the cab;
a skid plate disposed generally within the track;
a throttle cable having a first end and a second end, wherein the throttle cable is mechanically connected to the power source at the first end; and
a throttle control apparatus mechanically connected to the second end of the throttle cable, wherein the throttle control apparatus is mounted on the elongated handle.

11. The tracked powered machine of claim 10, further comprising a front shield wall on the cab.

12. The tracked powered machine of claim 11, wherein the track is constructed out of metal.

13. The tracked powered machine of claim 11, wherein the track is constructed out of rubber.

14. The tracked powered machine of claim 11, wherein the power source is an internal combustion engine.

15. The tracked powered machine of claim 14, wherein the internal combustion engine further comprises a mechanical clutch.

16. The tracked powered machine of claim 14, wherein the internal combustion engine further comprises a centrifugal clutch.

17. The tracked powered machine of claim 16, further including a trailer hitch mounted on the frame.

18. A tracked powered machine to create drag force comprising:
a front sprocket roller having a first side and a second side;
an axle disposed within the front sprocket roller and extending beyond the first side and the second side of the front sprocket roller;
a rear sprocket roller having a first side and a second side, the rear sprocket roller generally positioned linearly with the front roller along on a longitudinal axis of the device;
an axle disposed within the rear sprocket roller and extending beyond the first side and the second side of the front sprocket roller;
a track disposed around the front sprocket roller and the rear sprocket roller;
a plurality of rollers disposed generally within the track between the front sprocket roller and the rear sprocket roller;
a first support arm having a first distal end and a second distal end, said first support arm coupled to the front sprocket roller axle on the first distal end of the first support arm;
a second support arm having a first distal end and a second distal end, said second support arm coupled to the rear sprocket roller axle on the first distal end of the second support arm;
a frame coupled to the second distal end of the first support arm, and wherein said frame is additionally coupled to the second distal end of the second support arm;
a cab mounted on the frame, said cab having a front shield wall and a plurality of opposite side walls;
an internal combustion engine positioned within the cab, wherein the internal combustion engine is mechanically connected to the rear sprocket roller axle;
an elongated handle pivotably connected to one of the frame and the plurality of opposite side walls of the cab;
a throttle cable having a first end and a second end, wherein the throttle cable is mechanically connected to the internal combustion engine at the first end; and
a throttle control apparatus mechanically connected to the second end of the throttle cable, wherein the throttle control apparatus is mounted on the elongated handle.

19. The tracked powered machine of claim 18, wherein the internal combustion engine further includes a centrifugal clutch.

20. The tracked powered machine of claim 18, wherein the internal combustion engine further includes a mechanical clutch.
